(19) United States
(12) Patent Application Publication
(10) Pub. No.: US 2007/0128579 A1
(43) Pub. Date: Jun. 7, 2007

(54) Working model suited for extraoral fabrication

(76) Inventor: Fumio Shima, Komatsushima City (JP)

Correspondence Address: WENDEROTH, LIND & PONACK, L.L.P., 2033 K STREET N. W., SUITE 800, WASHINGTON, DC, 20006-1021, US

(21) Appl. No.: 11/399,539

(22) Filed: Apr. 7, 2006

(30) Foreign Application Priority Data
Dec. 2, 2005 (JP) 350009/2005

(51) Int. Cl. A61C 19/00; A61C 11/00

(52) U.S. Cl. 433/74; 433/34; 433/60

(57) ABSTRACT

The working model suited for extraoral fabrication has a dental cast connected via a dowel pin to a substrate in a predetermined position, the substrate including a gypsum forming frame and a gypsum portion. The frame has a peripheral wall being open in upper and lower faces, and is fabricated with plastics into a form of having a hollow space in the inner side of the peripheral wall. The gypsum portion has slurry of gypsum hardened which is filled in the hollow space of the frame. The working model is provided with a connection orifice for inserting the dowel pin into the gypsum portion which is filled and formed in the hollow space of the frame, so that the dowel pin is inserted into the connection orifice, thus connecting the dental cast to the substrate.

### BACKGROUND OF THE INVENTION

1. Field of the Invention

The present invention relates to a working model suited for extraorally fabricating various types of dental prostheses.

2. Description of the Related Art

A working model suited for extraoral fabrication (hereinafter referred to as a “working model”) is prepared by a dental surgeon in the following steps:
(1) to mold a dental cast by using dental gypsum, based on a dental impression taken from a patient's mouth;
(2) to plane and drill a bottom face of the dental cast, blast air into such a drilled hole, and then clean it up by jetting pressurized water;
(3) to secure a dowel pin in the drilled hole by means of instantaneous adhesive, super-quick hardening resin, gypsum, etc.;
(4) to remove residual gypsum, adhesive, and resin, for shaping up the dental cast;
(5) to provide an anti-rotation groove to the dental cast; and
(6) to coat a releasing agent on the bottom face of the dental cast as well as on asurface of the dowel pin, then press the cast and pin onto a silicone rubber mold which serves as a substrate being filled, in advance, with slurry of gypsum, and finally release the dental cast out of the mold after the gypsum is hardened, so that a working model may thus be ready for prosthetic dentistry.

Fabrication of a working model in the above-described method has drawbacks of a less efficient procedure because a large portion of manual work is often needed, involving a high skill and consumed time. In order to overcome such drawbacks, the present inventor has developed a working model suited for extraoral fabrication as illustrated in FIG. 1 (refer to Unexamined Japanese Patent Application (Kokai) No. 2000-245749).

This working model has a substrate 31 connected with a fixation plate 32 in a predetermined position. Fixed on the fixation plate 32 is a dental cast 34. Fixed onto a bottom surface of the fixation plate 32 is a dowel pin 33, so that the fixation plate 32 can stay fixed to the substrate 31 in a predetermined position. The substrate 31 is provided with a connection orifice 35 for releasably inserting the dowel pin 33.

The working model as illustrated in FIG. 1 is provided with an elevated area 36 which is integrally formed on the top of the substrate 31, so that the dental cast 34 may be easily disconnected together with the fixation plate 32. The elevated area 36 is contoured in the same external form as the dental cast 34, so that both of the dental cast 34 and the fixation plate 32 may be cut away without much difficulty. A working model with this structure is designed such that the entire substrate 31 is made of gypsum to enable the dental cast 34 and the fixation plate 32 to be cut away together. Such an easy cut has been made possible because the dental cast 34 and fixation plate 32 are disconnected together with the elevated area 36.

A working model with such structure, however, has a drawback that time is consumed in fabricating the substrate, because the substrate is made by filling slurry of gypsum in a silicone rubber mold. Such a working model also has a drawback that the substrate totally made of gypsum will lack its overall strength, being prone to be easily broken or damaged when subjected to shocks. There is another drawback that the working model cannot be easily and accurately mounted onto a dental articulator and that the working model is likely to be displaced from its appropriate mounted position on the dental articulator. This may occur because a gypsum-made substrate is less precise in its form and dimension, and also because the mounted portion cannot be made sufficiently strong. Even another drawback exists in its expensive cost of manufacture, in that an inexpensive and efficient mass production cannot be expected of a substrate which is to be fabricated after filling and hardening slurry of gypsum in a mold prior to being released out of the mold.

The disadvantage of the substrate having a lower accuracy in form and dimension can certainly be remedied by fabricating the whole substrate with plastics. A substrate totally made of plastics, however, would have a drawback that a position for inserting a dowel pin is specified, because a connection orifice for inserting a dowel pin has to be provided during a step of forming the substrate with plastics. A uniform shape is not available for a dental cast fixed onto the substrate, with the cast being of varied forms and dimensions depending on patients. Since the dowel pin 33, as shown in FIG. 1, is used to detachably connect a disconnected dental cast 34A to the substrate 31, it is required that at least one dowel pin 33 be connected to the disconnected dental cast 34A. This means that the substrate needs to have a multitude of connection orifices for the dowels to be inserted so that when a cutting position is changed, a dowel pin can be connected to each individual piece of cut dental cast (refer to Unexamined Japanese Patent Application (Kokai) No. H10-201774). With a smaller number of dowel pins, a dowel pin may not be connected to the cut dental cast, depending on a position where the cast is to be cut. For this reason, a plastic substrate is provided with a multitude of connection orifices, where a multitude of dowel pins are inserted. Thus, such a working model with an increased number of dowels pins to be used will become costly for manufacture, and it may also have a drawback that a dowel pin cannot be connected to the cut dental cast in its best-suited position.

### SUMMARY OF THE INVENTION

The present invention has thus been made in an attempt to solve such drawbacks. A primary object of this invention is to provide a working model suited for extraoral fabrication, in which a substrate surface is robustly structured to reduce damages and breaks to minimum, a substrate is contoured with a higher accuracy to allow the working model to be firmly mounted onto a dental articulator in a predetermined position, and further a smaller number of dowel pins may be employed to reduce a cost of manufacture, so that a dental cast with a variable form can be cut away for connection to the substrate by means of a dowel pin situated in an ideal position.

The inventive working model suited for extraoral fabrication includes the following constituents in order to achieve the above-described object.

The working model includes a substrate and a dental cast, the dental cast being connected via a dowel pin to the substrate in a predetermined position. The substrate includes a gypsum forming frame (hereinafter referred to as a “frame”) and a gypsum portion. The frame has a peripheral wall being open in its upper and lower faces, and is fabricated with plastics in a form such that a hollow space is defined inside the peripheral wall. The gypsum portion is obtained by hardening slurry of gypsum which is filled in the hollow space of the frame. The working model is provided with a connection orifice that allows the dowel pin to be inserted into the gypsum filled in the hollow space of the frame, so that the dental cast is thus connected to the substrate.

The above-described working model is characterized in that the substrate surface is robustly structured to reduce damages and breaks to minimum, and also in that the substrate is contoured with a higher accuracy to allow the working model to be firmly mounted on the dental articulator in a predetermined position. The working model is also characterized in that a smaller number of dowel pins are employed to reduce a cost of manufacture, so that the dowel pin, connected in an ideal position of every dental cast which is not cut away in a specific position, can be connected to the substrate. Such features are achieved in this working model by the fact that the substrate is constituted by the plastic frame and the gypsum portion for allowing slurry of gypsum to be filled and hardened in the hollow space of the frame. The substrate is so structured as to have its inner side formed by hardening the slurry of gypsum into the gypsum portion and to have the peripheral face covered by the peripheral wall of plastic frame, so that the peripheral face may be formed with strength and accuracy incomparably superior to a conventional gypsum-used structure. Thus, these characteristics enable the substrate to be firmly mounted onto the dental articulator in an accurate position.

Furthermore, this working model has the peripheral face of the gypsum portion covered and reinforced with the plastic frame, allowing the lower extremity of the connection orifice to be open which is provided in the gypsum portion. This is made possible because the peripheral wall of the plastic frame is so shaped as to be open in the upper and lower extremities. The connection orifice being open in the lower extremity allows foreign matter to be expelled out of the lower end opening. Thus, the working model is characterized in that the dowel pin can be inserted in an accurate position of the connection orifice so that the dental cast is connected via the dowel pin to an accurate position in the substrate.

The inventive working model can be provided with a fitment part to allow the plastic frame to be fittingly connected to the dental articulator.

This working model is characterized in that provision of the fitment parts in the frame for fittingly connecting to the dental articulator enables the plastic frame to be firmly connected to the dental articulator by connecting the fitment parts to the dental articulator in a fitting relation.

The inventive working model allows the lower end opening of the frame to be closed by means of a detachable closure cover.

In this working model, closure of the lower end opening of the frame by means of the detachable closure cover enables slurry of gypsum to be filled and hardened in the hollow space of the frame while the lower end opening is closed with the closure cover. Also, a lower extremity of the connection orifice can be made open by removing the closure cover after the slurry of gypsum has been hardened.

The inventive working model can also be prepared with a sheet material as the closure cover for releasably connecting to the lower end opening's rim of the frame.

Since the sheet material is used as a closure cover for releasably connecting to the lower end opening's rim of the frame, this working model allows the sheet material to be easily peeled and removed after the slurry of gypsum has been hardened into the gypsum portion in the hollow space of the frame.

The inventive working model can also be prepared with a rubber-like elastic material as the closure cover for detachably connecting to the lower extremity of the frame.

Since the rubber-like elastic material is used as the closure cover for detachably connecting to the lower extremity of the frame, this working model allows the closure cover to surely close the lower extremity of the frame and also to be easily detached from the frame after the slurry of gypsum has been filled and hardened in the hollow space of the frame.

The inventive working model allows a tip of dowel pin to be extractably inserted into the bottom portion of the frame, also enabling an insertion plate to be disposed which can be separated from the frame when the slurry of gypsum has been hardened in the gypsum portion.

Since the tip of the dowel pin is extractably inserted into the bottom portion of the frame in this working model, and also the insertion plate is disposed which can be separated from the frame when the slurry of gypsum has been hardened in the gypsum portion, the lower extremity of the dowel pin can be inserted into the insertion plate prior to the slurry being filled, so that the lower extremity of the dowel pin projects from the gypsum portion after the slurry of gypsum has been filled and hardened. As the lower extremity of the dowel pin can project from the gypsum portion by means of the insertion plate, the lower extremity of the dowel pin need not be projected through excising the gypsum when the slurry is hardened. In particular, when the insertion plate is disposed at the bottom portion of the frame to allow the lower extremity of the dowel pin to be projected, the lower extremity of the dowel pin can be arranged not to project farther than the lower rim of the frame.

The inventive working model allows the gypsum portion to have an elevated area staying above the upper rim of the peripheral wall of the frame.

Since this working model is provided with the gypsum portion adapted to have an elevated area staying above the upper rim of the peripheral wall of the frame, the working model is characterized in that the dental cast can be surely disconnected by cutting the elevated area together when cutting the dental cast.

Furthermore, the inventive working model may be provided with an inner wall integrally formed inside the peripheral wall of the frame so that the inner side of the inner wall can serve as a hollow space.

Since the frame of this working model is provided with an inner wall integrally formed inside the peripheral wall so that the inner side of the inner wall is a hollow space, the volume of the hollow space can be reduced. Advantageously, with this working model, a cost of manufacture can be reduced because the amount of slurry of gypsum can be reduced for filling in the hollow space of the frame. It is also advantageous that the frame having the inner wall inside can have an overall strength increased.

The above and further objects of the present invention as well as the features thereof will become more apparent from the following detailed description to be made in conjunction with the accompanying drawings.

### BRIEF DESCRIPTION OF THE DRAWINGS

FIG. 1 is a front view of the working model suited for extraoral fabrication as previously developed by the inventor;

FIG. 2 is a cross-sectional view of the working model in accordance with one embodiment of the present invention;

FIG. 3 is an exploded perspective view of the working model as shown in FIG. 2;

FIG. 4 is a bottom perspective view of the working model as shown in FIG. 2;

FIG. 5 is a perspective view showing another example of the frame;

FIG. 6 is a cross-sectional perspective view of the frame as shown in FIG. 5;

FIG. 7 is a perspective view showing an exemplary dental articulator for mounting the working model as shown in FIG. 2;

FIG. 8 is an exploded perspective view showing an exemplary step of fabricating the working model as shown in FIG. 2;

FIG. 9 is a cross-sectional view showing an exemplary step of fabricating the working model as shown in FIG. 2;

FIG. 10 is a cross-sectional view showing an exemplary step of fabricating the working model as shown in FIG. 2;

FIG. 11 is an exploded perspective view showing another exemplary step of fabricating the working model as shown in FIG. 2;

FIGS. 12 through 15 are cross-sectional views of other exemplary steps of fabricating the working model as shown in FIG. 2;

FIG. 16 is a front view showing how a sectional cast is extracted in the working model as shown in FIG. 2;

FIG. 17 is a cross-sectional view of the working model in accordance with an alternative embodiment of the invention;

FIG. 18 is an exploded perspective view of the working model as shown in FIG. 17;

FIG. 19 is a perspective view of the working model in accordance with another embodiment of the invention; and

FIG. 20 is an exploded perspective view of the working model as shown in FIG. 19.

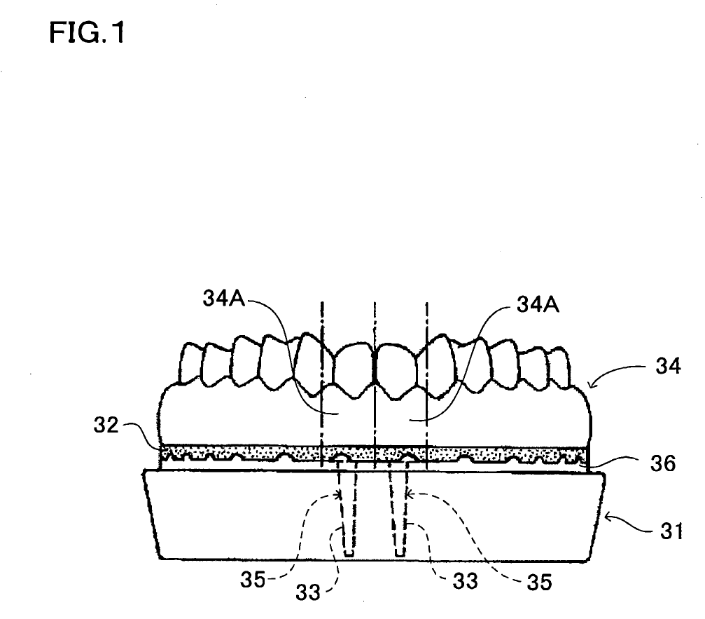

### DETAILED DESCRIPTION OF THE PREFERRED EMBODIMENT

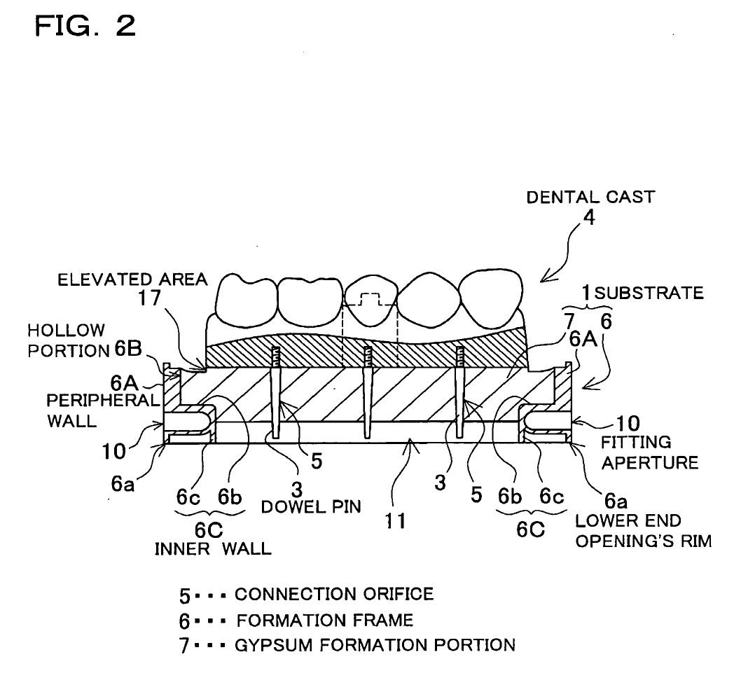

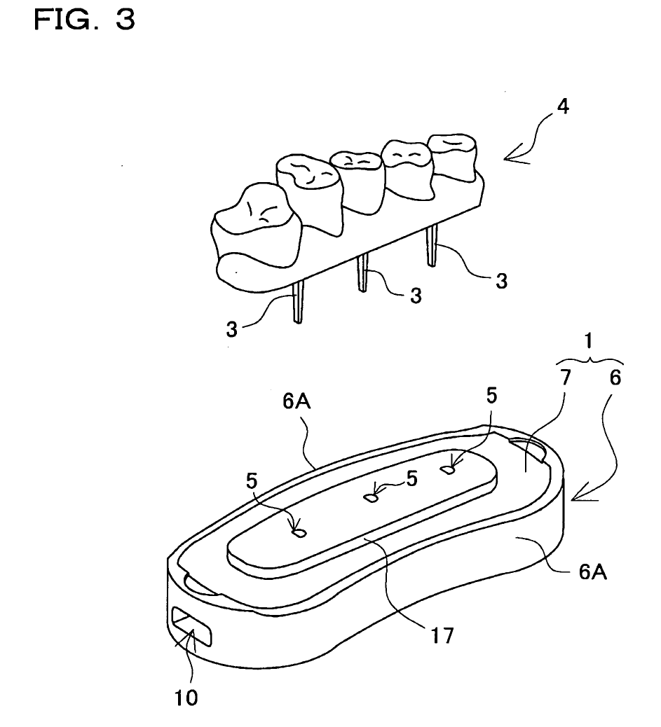

Like elements in alternative embodiments shall have an additional numeral 6, 7 or 9 prefixed to the original reference numerals given throughout the drawings, e.g., 910 for 10, and the element with such a prefix shall not be specifically described. The working model suited for extraoral fabrication shown in FIGS. 2 through 4 includes a substrate 1 and a dental cast 4, the dental cast being connected via a dowel pin 3 to the substrate 1 in a predetermined position.

The substrate 1 includes a frame 6 and a gypsum portion 7, with the frame 6 having a peripheral wall 6A that is open in upper and lower faces, and with the gypsum portion 7 being provided in a hollow space 6B of the frame 6. The substrate 1 is provided with the gypsum portion 7 that is hardened from slurry of gypsum being filled in the hollow space 6B of the frame 6.

The illustrated substrate 1 is in a planar form with a curved contour. However, since the substrate is used for fixing a dental cast, the substrate is shaped to be substantially equal to the planar form of the dental cast. In most cases, the dental cast 4 is either in an arcuate form as shown or in a semioval form to be described below. The substrate 1 can, therefore, be connected to almost any dental cast as far as the substrate is in an arcuated planar form or in a semioval form.

The frame 6 is fabricated with plastics into a form with the hollow space 6B defined inside the peripheral wall 6A. The plastic material may be available from polystyrene, polypropylene, ABS, and the like. Also possible is a plastic material containing pulp such as of recycled paper, or a biodegradable plastic material. While the frame 6 can be strengthened by making the peripheral wall thicker, an involved cost of manufacture will be increased. On the other hand, when the peripheral wall is made thinner to reduce such a cost of manufacture, the strength will in turn become insufficient to hold the frame in a desired form. In view of these factors, a thickness of the peripheral wall should, therefore, be in a range between 0.3 and 10 mm, preferably between 0.5 and 5 mm, and more preferably between 1 and 3 mm.

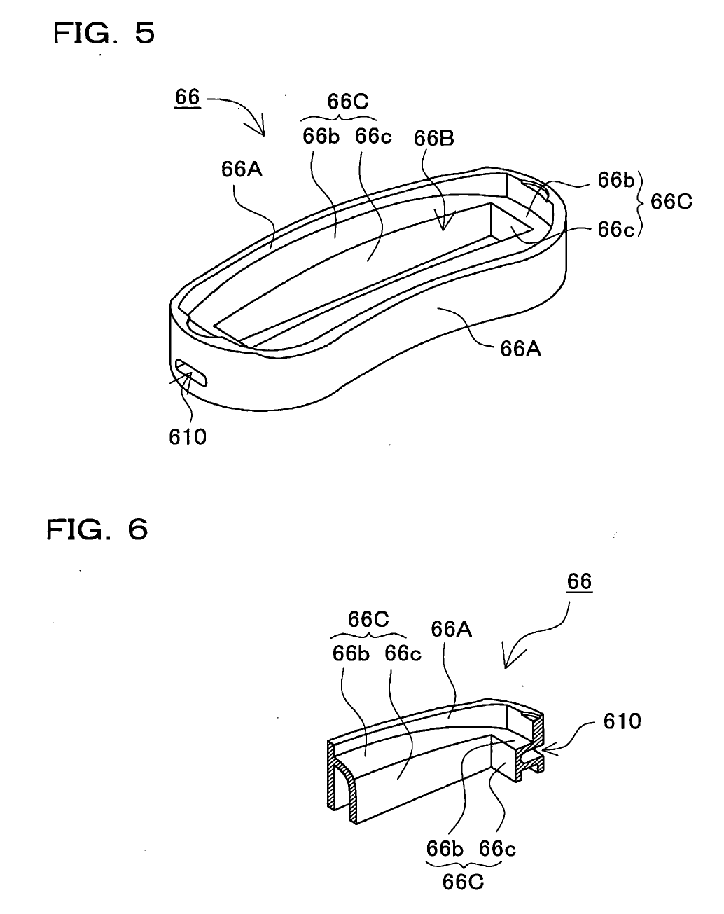

Further, as shown in FIGS. 5 and 6, the frame can also be provided with an inner wall 66C inside a peripheral wall 66A. The illustrated frame 66 is provided with an upwardly facing shoulder 66b projecting inwardly from an inner face of the peripheral wall 66A as well as being provided with an upright wall 66c extending downwardly from the tip of the upwardly facing shoulder 66b, so that the frame 66 is provided with an inner wall 66C of an offset or setback form inside the peripheral wall 66A. While the illustrated frame 66 is provided with the inner wall 66C throughout the inner side of the peripheral wall 66A, the frame can also be provided with such an inner wall running partially along the peripheral wall. There is a sufficient space given between the oppositely facing inner walls 66C projecting inside the peripheral wall 66A so that a dowel pin may be inserted which is fixed to the dental cast. The frame can be provided with the inner wall such that the space between the inner wall and the dowel pin is preferably greater than 2 mm. The structure with the inner wall 66C being provided inside the peripheral wall 66A can advantageously reduce the volume of the hollow space 66B to save the amount of slurry of gypsum filled to form a gypsum portion. When a smaller amount of slurry is needed, such a working model would also be more advantageous in that a cost of manufacture can be reduced and time can be saved for hardening the slurry. In particular, it is advantageous to be able to form the gypsum portion with a smaller amount of slurry while maintaining an identical form and appearance of the substrate. In addition, there is also an advantage that the frame provided with an inner wall inside makes it possible to increase the strength. Although not illustrated, the strength can further be increased by connecting a vertical wall of the inner wall via a rib to the lower extremity of the peripheral wall. The entire frame may also be fabricated by integrating the peripheral wall and the inner wall into a single wall.

The frame 6, 66 shown in FIGS. 2 through 6 is provided with fitting apertures 10, 610 as fitment part located at both side faces in a longitudinal direction, i.e., at the mutually opposite side faces, so that the apertures are fittingly connected to a dental articulator. The illustrated frame 6, 66 is provided with the fitting apertures 10, 610 of a dented form which project inwardly from the peripheral wall 6A, 66A. The illustrated frame 6, 66 is provided with the fitting apertures 10, 610 in a space between the peripheral wall 6A, 66A and the inner wall 6C, 66C. However, the frame can also be provided with the fitting apertures which project inwardly, without the inner wall. In such frame, the portion projecting inwardly from the peripheral wall is buried in the gypsum portion.

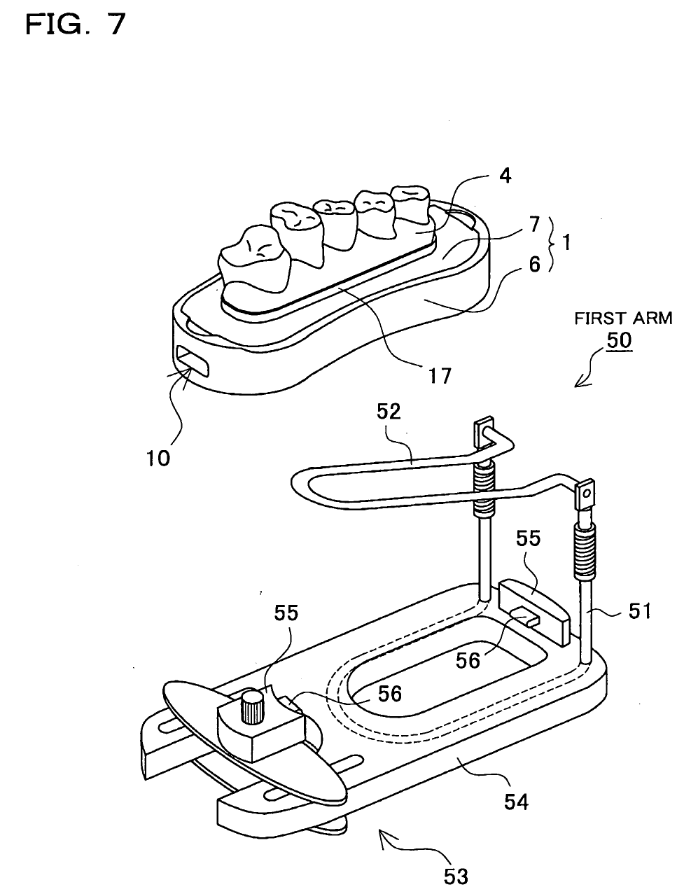

The working model is used as a dental articulation device by fixedly mounting the substrate 1 onto a dental articulator 50, as shown in FIG. 7. The illustrated dental articulator 50 has a first arm 51 and a second arm 52 connected for relative tilt or rotation, and the working model is mounted via a releasably mounting aid 53 to the first arm 51. The releasably mounting aid 53 shown includes a pair of retention walls 55 spaced apart from each other for retaining both ends of the substrate 1 from the opposing positions, and the pair of retention walls 55 are connected to a fixation plate 54 which is fixed to the first arm 51. The fixation plate 54 fixed to the first arm 51 has its top surface as a horizontal plane, which serves as a mounting plane for mounting the working model. The pair of retention walls 55 is so structured as to be detachably connected to opposing lateral extremities of the substrate 1 by virtue of such fitting arrangement.

The illustrated substrate 1 is provided with concaved fitting apertures 10 at the opposing lateral extremities of the frame 6 to allow the fitting portions 56 of the retention walls 55 to be inserted into the fitting apertures 10, so that the substrate may be fitted onto the dental articulator 50. For this purpose, the retention walls 55 of the releasably mounting aid 53 has convexed fitting portions 56 which face and fit into the concaved apertures 10. However, although not illustrated here, the fitting apertures on the frame of the substrate can be reversed into convexity, while the fitting portions on the retention walls can be reversed into concavity to fit with the convexed fitting portions on the frame. In manipulating the above-described releasably mounting aid 53, the working model is placed onto the mounting plane, the pair of retention walls 55 are then pushed toward each other for allowing the substrate 1 to be caught between the retention walls 55 from both sides, and the fitting apertures 10 of the substrate 1 are allowed to fit with the fitting portions 56 of the retention walls 55, so that the working model may thus be fixedly mounted onto the dental articulator 50.

The gypsum portion 7 is fabricated by hardening the slurry of gypsum filled in the frame 6. The gypsum portion 7 is provided with a connection orifice for inserting a dowel pin 3. Each connection orifice 5 is provided in the gypsum portion 7 in a mutually parallel, vertical position. Further, since the dowel pin 3 is tapered off toward its tip, the connection orifice 5 is also designed to be tapered off toward its lower extremity, so that the dowel pin 3 may be matingly inserted into the connection orifice without leaving a space in the orifice. With the dowel pin 3 being disposed in the hollow space 6B of the frame 6, the gypsum portion 7 is filled with the slurry of gypsum, having the connection orifice positioned to match with the dowel pin 3.

The connection orifice 5 is also open at the lower extremity of the gypsum portion 7. This arrangement is for purposes of allowing the dowel pin 3 to project from the lower end face of the gypsum portion 7. In the case of the substrate 1 shown in FIG. 2, the lower end face of the gypsum portion 7 is disposed above the lower end opening's rim 6a of the frame 6, with the lower extremity of the dowel pin 3 being allowed to project farther from the lower end face of the gypsum portion 7. Thus, the thickness of the gypsum portion 6 is such a thickness as to allow the dowel pin 3 to be inserted from top to bottom and projected at the lower extremity of the pin, as shown in FIG. 2. In this substrate 1, the lower end opening's rim 6a of the frame 6 is disposed below the lower extremity of the dowel pin 3 which is inserted into the connection orifice 5, or alternatively, the rim 6a is flush with the lower extremity of the dowel pin 3. In other words, the substrate 1 is structured such that the dowel pin 3 will not project farther from the lower end opening's rim 6a. In this substrate 1, the dowel pin 3 inserted in the connection orifice 5 does not project farther from the lower end opening's rim 6a of the frame 6, so that when the substrate 1 is mounted onto the dental articulator, the dowel pin 3 does not contact the mounting area of the dental articulator, enabling the substrate 1 to be mounted onto the dental articulator in an accurate position. On the other hand, the dental articulator may also be provided with a recess for guiding that portion of the dowel pin which projects from the bottom of the substrate, so that the projecting portion of the dowel pin may be guided into the recess. As such, in the inventive working model, the dowel pin may project from the bottom face of the substrate.

Furthermore, the illustrated gypsum portion 7 has an elevated area 17 where the central portion, to which the dental cast is connected, is elevated above the upper rim of the peripheral wall 6A of the frame 6. In this manner, the gypsum portion 7, which has the elevated area 17 staying above the upper rim of the peripheral 6A of the frame 6, enables the dental cast 4 fixed onto it to be easily cut away. This is made possible because a sectional cast can be fabricated while cutting, together with the dental cast 4, the upper surface of the elevated area 17 made of easy-to-cut gypsum. In the illustrated frame 6, the peripheral wall 6A situated at opposing ends in the longitudinal direction is formed to stay above the peripheral wall 6A situated at opposing ends in the transversal direction. The illustrated gypsum portion 7 is provided with an elevated area 17 staying above the peripheral wall 6A situated at the opposing ends in the transversal direction, or in other words, above the upper end rim of the peripheral wall 6A extending in the longitudinal direction. The dental cast 4 fixed on the top of the substrate 1 is cut out in the transversal direction as viewed in the drawing to form the sectional cast. Thus, the gypsum portion 7 enables the sectional cast to be more efficiently fabricated by providing the elevated area 17 staying above the upper end rim of the peripheral wall 6A situated at opposing ends in the transversal direction.

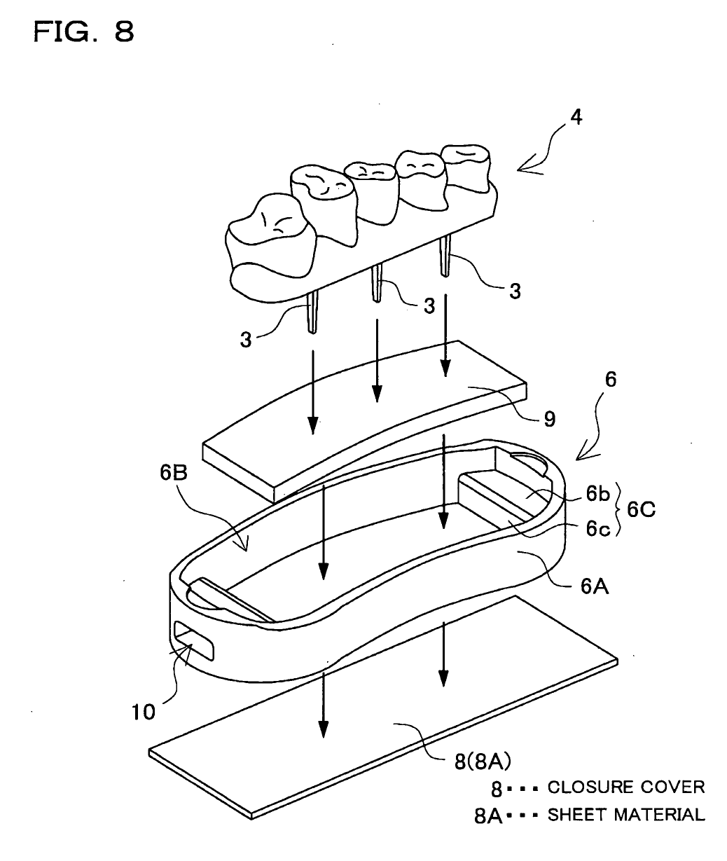

In the frame 6 as shown in FIGS. 8 through 10, the lower end opening is closed by a separable closure cover 8 in order to form a gypsum portion 7 in the hollow space 6B. The closure cover 8 shown in FIGS. 8 through 10 is a sheet material 8A which is releasably connected to the lower end opening's rim 6a of the frame 6. The closure cover 8 in the form of sheet material 8A is adhesively and releasably connected to the lower end opening's rim 6a of the frame 6. For this sheet material 8A, any sheet may be used that could prevent a water content from leaking out, which is contained in the slurry of gypsum filled in the frame 6. The sheet material 8A may be, for example, a plastic sheet, a waterproofed nonwoven fabric or woven fabric, oiled paper, etc. The sheet material 8A to be bonded to the lower end opening's rim 6a may have a larger area than the external form of the frame 6, as illustrated. The sheet material 8A can thus be easily released by manually pulling a portion extending outwardly from the frame 6.

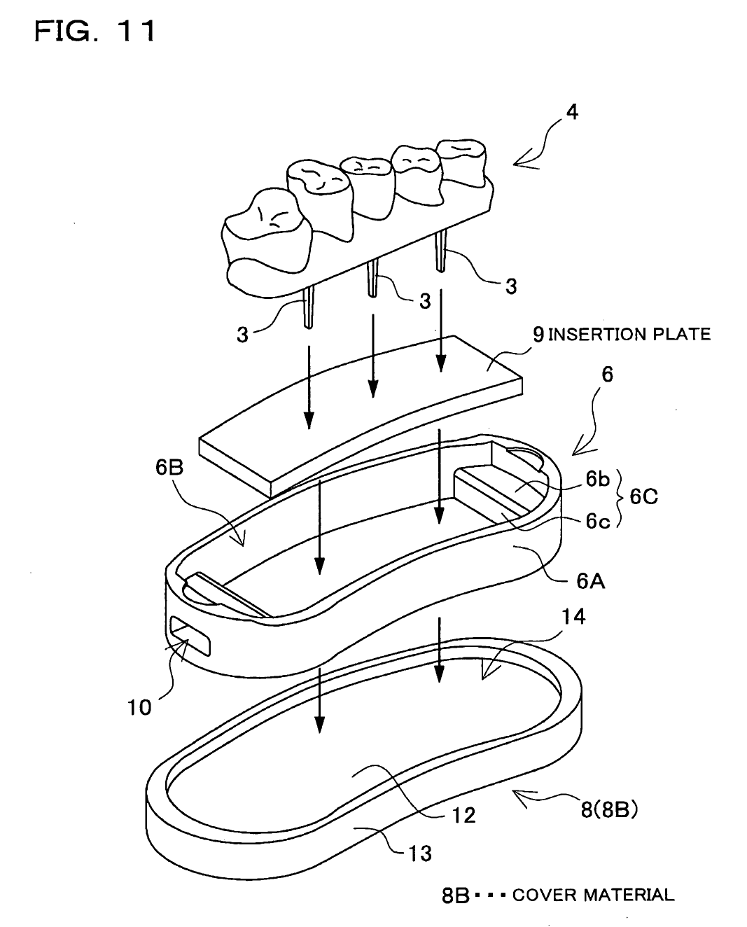

The closure cover 8 shown in FIGS. 11 through 13 is a rubber-like elastic cover material 8B which is detachably connected to the lower extremity of the frame 6. The cover material 8B in the form of rubber-like elastic materials is made of silicone rubber which can be freely deformed by hands so that the frame 7 can be easily released. The cover material may also be made of other kinds of rubber than silicone rubber, or plastics. The cover material 8B is provided with a peripheral wall 13 surrounding a bottom surface 12, where an upper open mounting recess 14 may be formed. The cover material 8B is so designed as to be tightly connected to the peripheral wall 6A of the frame 6 by making up the internal form for forming the mounting recess 14 to be substantially equal to or slightly smaller than the external form of the frame 6. The cover material 8B is connected to the frame 6 by inserting the bottom end of the frame 6 into the mounting recess 14 while elastically deforming the peripheral wall 13 and enabling the peripheral surface of the peripheral wall 6A to be in tight contact with the inner surface of the peripheral wall 13. The cover material 8B with this structure can advantageously reduce a cost of manufacturing the substrate 1 because the cover material can be repeatedly used.

As described above, with the structure for closing the lower end opening of the frame 6 by means of the separable closure cover 8, the slurry of gypsum is filled in the hollow space 6B to mold the gypsum portion 7 while the lower end opening of the frame 6 is closed by the closure cover 8. After the slurry has been hardened, the closure cover 8 is removed, so that the substrate 1 is obtained as shown in FIG. 2.

Furthermore, the frame 6 shown in FIGS. 8 through 13 and 15 has an insertion plate 9 disposed at the bottom of the hollow space 6B in order to allow the dowel pin 3 to project farther from the lower end face of the gypsum portion 7. The insertion plate 9 to be disposed at the bottom of the frame 6 is a plastic foam with such a predetermined thickness as may allow the tip of the dowel pin 3 to be pierced. The insertion plate 9 is made preferably of expanded polystyrene. The insertion plate 9 made of expanded polystyrene is characterized in that the plate is available at a lower cost by virtue of a mass production. In the present invention, however, the insertion plate is not limited to the expanded polystyrene alone. For such an insertion plate, a variety of plastic foam may be employed which could be pierced with the tip of the dowel pin, including expanded urethane, expanded EVA, expanded PVC, etc. Further, a resin coated or impregnated paper sheet and a corrugated cardboard sheet may also be employed for the insertion plate.

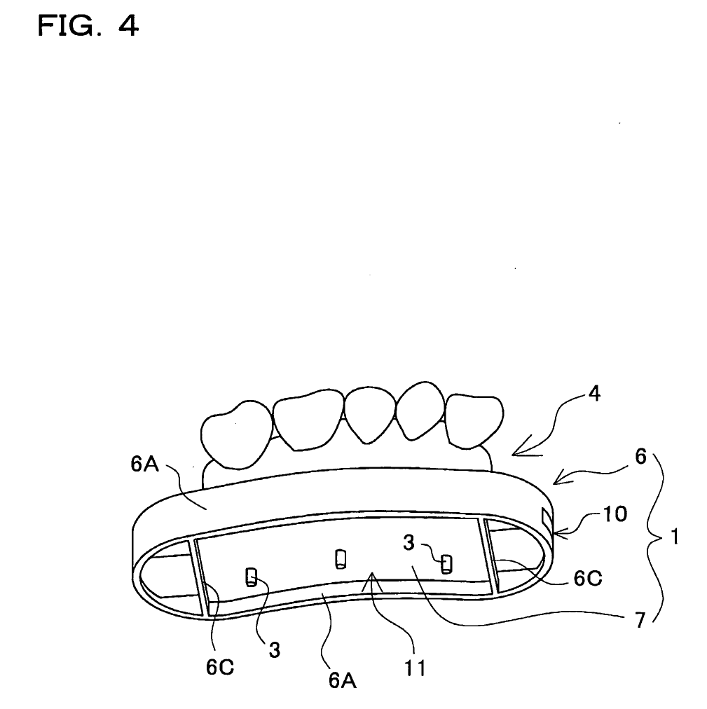

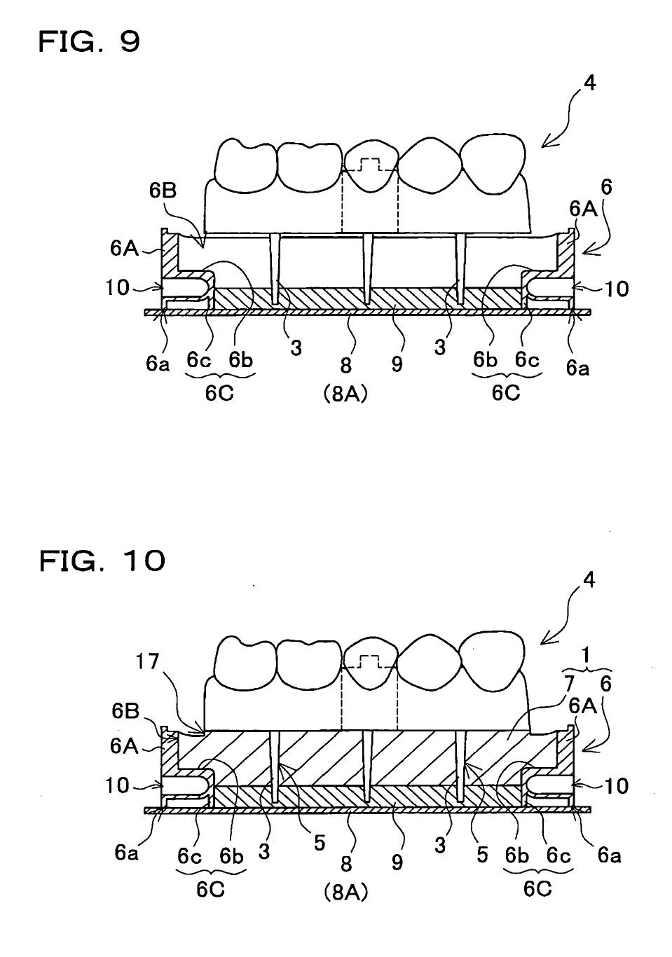

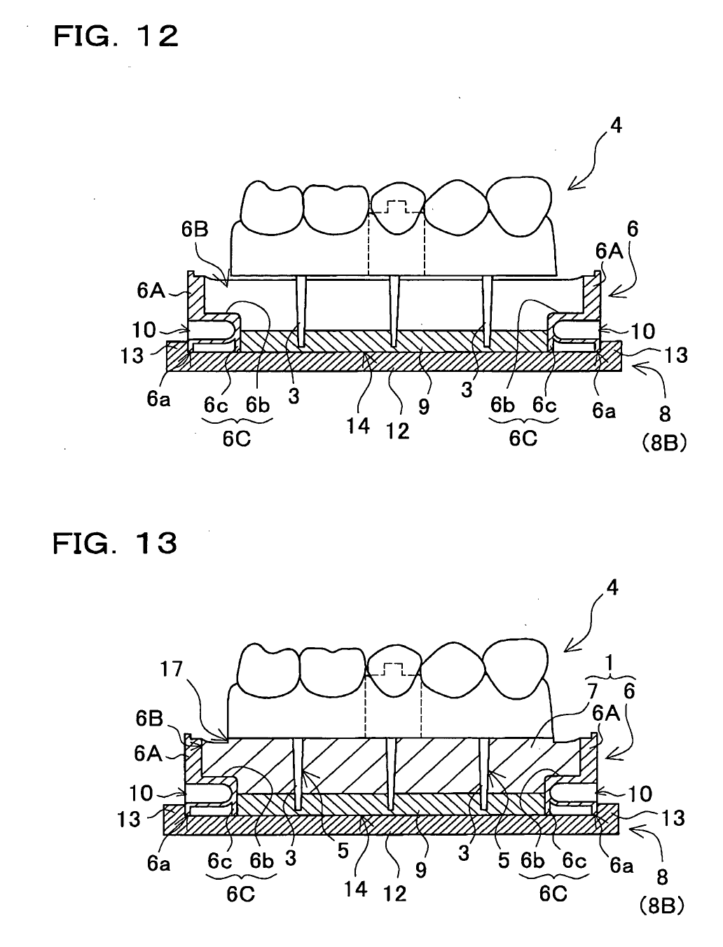

The insertion plate 9, as shown in FIGS. 9 and 12, is employed to prevent the tip of the dowel pin 3 from being buried in the gypsum when the slurry of gypsum is filled in the frame 6, with the tip of the dowel pin 3 remaining inserted into the insertion plate 9. In other words, the slurry is not filled to reach the tip of the dowel pin 3 inserted in the insertion plate 9. As such, the thickness of the insertion plate 9 is set to be a thickness ranging, for example, between 1 and 6 mm, preferably between 2 and 5 mm, and most preferably between 2 and 4 mm, which thus allows the tip of the dowel pin 3 to project farther from the gypsum. In the substrate 1 having the insertion plate 9 disposed at the bottom of the frame 6, the insertion plate 9 is removed after the gypsum portion 7 has been formed, so that the bottom has a recessed portion 11 formed, as shown in FIG. 4, which allows the tip of the dowel pin 3 to be exposed out of the gypsum portion 7. The thickness of the insertion plate 9 will therefore determines a specific depth of the recessed portion 11 provided at the bottom of the substrate 1.

The external form of the insertion plate 9 is designed to be substantially equal to the internal form of the bottom of the hollow space 6B in the frame 6. The frame 6 shown in FIGS. 2 and 4 is, at the opposing ends in the longitudinal direction, provided with the inner wall 6C inside the peripheral wall 6A, with the inner side of this internal wall 6C constituting the hollow space 6B. The illustrated inner wall 6C is so shaped as to connect the opposing peripheral walls 6A in the transversal direction, with the upright wall 6c being extended to be flush with the plane of the lower end opening's rim 6a of the peripheral wall 6A. The frame 6 has the insertion plate 9 disposed in the internal space between the upright wall 6c of the internal wall 6C and the peripheral wall 6A extended in the longitudinal direction. As such, the recessed portion 11 provided in the bottom face of the substrate 1 is made up with the upright wall 6c of the internal 6C and the peripheral wall 6A. In the drawing, 6b designates an upwardly facing shoulder. Further, the frame 66 shown in FIGS. 5 and 6 has an insertion plate which is so shaped as to run along the internal circumference of the upright wall 66c of the inner wall 66C which is provided inside the peripheral wall 66A.

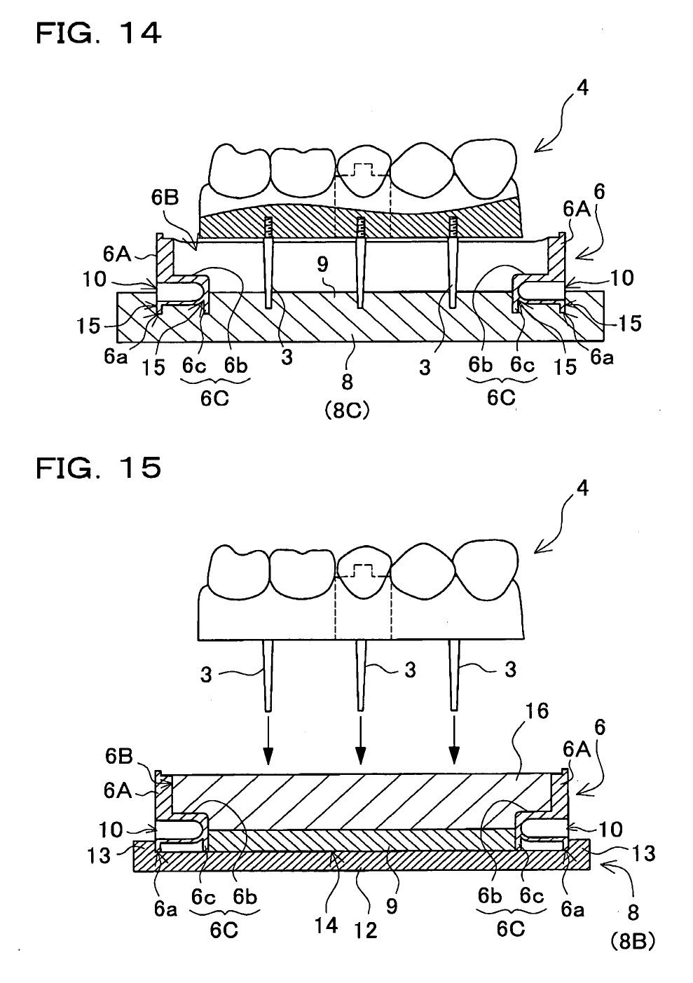

Furthermore, in the frame 6, the lower end opening can also be closed by means of a closure cover 8 as shown in FIG. 14. This closure cover 8 is a cover material 8C made of a plastic foam having a predetermined thickness. The cover material 8C is preferably made of expanded polystyrene. The cover material 8C made of expanded polystyrene is provided with an insertion groove 15 for inserting the lower extremity of the frame 6. The insertion groove 15 can be easily formed, for example, by thermally pressing the same type of metal frame as the frame 6 onto the expanded polystyrene plate. In this cover material 8C, with the lower extremity of the frame 6 being inserted in the insertion groove 15, the central portion of the cover material 8C made of expanded polystyrene is inserted into the bottom portion of the hollow space 6B. In this cover material 8C, the portion to be inserted into the hollow space 6B can be used to serve as an insertion plate, into which the dowel pin 3 can be inserted. Thus, the dental cast 4 can be disposed in a predetermined position.

The dowel pin 3 is connected to the dental cast 4. The dowel pin 3 is a metal rod, such as stainless steel, and is tapered off toward the lower extremity. The dowel pin 3 may be shaped in a circular, oval or polygonal column which is tapered off toward its tip.

The above-described working model is fabricated in the following manner:

[Step of Fabricating Dental Cast]

The dental cast 4 is made of gypsum, being based on a dental impression taken from a patient's mouth. At this stage, a given number of dowel pins 3 are fixedly buried in the dental cast 4 in a predetermined position.

[Step of Disposing Closure Cover and Insertion Plate in Frame in Predetermined Position]

As shown in FIGS. 8, 9, 11, 12 and 14, the closure cover 8 is mounted to the lower end opening of the frame 6. The closure cover 8 to be mounted to the lower extremity of the frame 6 may be either a sheet material 8A as shown in FIGS. 8 and 9, or a cover material 8B as shown in FIGS. 11 and 12, or even another cover material 8C as shown in FIG. 14. The insertion plate 9 is disposed in the bottom of the frame 6 having the closure cover 8 mounted to the lower end opening. In the case of the cover material 8C in FIG. 14, the central portion inserted into the bottom of the frame 6 will also serve as an insertion plate.

[Step of Temporarily Fixing Dental Cast to Frame in Predetermined Position]

Prior to the lower extremity of the dowel pin 3 being inserted into the insertion plate 9, a releasing agent is coated on the bottom surface of the dental cast 4 and on the surface of the dowel pin 3, both surfaces being portions to be separated from the gypsum portion 7. The dowel pin 3 inserted into the insertion plate 9 is vertically supported on and with respect to the insertion plate 9. The dowel pin 3 allows the dental cast 4 to be disposed in a predetermined position. That is, the dental cast 4 is temporarily fixed, via the dowel pin 3 and the insertion plate 9, to the frame 6 in a predetermined position. As an auxiliary means for taking this position, however, the dental cast may also be temporarily fixed to the frame, employing an alternative temporary fixation device.

[Step of Filling Slurry of Gypsum in Frame]

While the dental cast 4 is temporarily fixed, the slurry of gypsum is filled in the frame 6 as shown in FIGS. 10 and 13. At this stage, the slurry is filled elevationally above the upper rim of the peripheral wall 6A of the frame 6, so as to form, with the gypsum, the elevated area 17 abutting against the lower surface of the dental cast 4. The gypsum filled elevationally above the upper rim of the frame 6 is trimmed around the outside of the dental cast 4. This portion of gypsum can be easily trimmed by running a tool such as a spatula, for example along the upper rim of the frame and the peripheral wall of the dental cast 4. When the gypsum has been trimmed in this portion, an elevated area 17, staying above the upper rim of the frame 6, is formed with the gypsum beneath the dental cast 4.

The slurry of gypsum is hardened inside the frame 6 to form the gypsum portion 7. The gypsum portion 7 thus obtained from the hardened slurry is provided with a connection orifice 5 for inserting the dowel pin 3, and the tip of the dowel pin 3 is allowed by the insertion plate 9 to project from the bottom.

[Step of Removing Closure Cover and Insertion Plate from Frame]

The closure cover 8 is removed from the frame 6, and then the insertion plate 9 is separated from the bottom surface of the substrate 1 and the lower extremity of the dowel pin 3. The substrate 1 thus formed has a recessed portion 11 provided in the bottom surface, being formed by the insertion plate 9, so that the lower extremity of the dowel pin 3 is allowed to extend through the recessed portion 11. That is, the connection orifice 5 is set to be open in the bottom surface.

Alternatively, in this working model, the gypsum portion may also be formed by closing the lower end opening of the frame 6 by means of the closure cover 8 and disposing the insertion plate 9 in the bottom of the hollow space 6B, so that the slurry of gypsum 16 may be filled in the frame 6 and then the dowel pin 3 may be inserted into the slurry of gypsum 16 before the slurry is hardened, as shown in FIG. 15. At this stage, the dowel pin 3 disposed on the dental cast 4 is inserted into the slurry until the lower extremity of the dowel pin reaches to be inserted into the insertion plate 9. The dental cast 4 is vertically supported by the dowel pin 3 inserted into the insertion plate 9 and is temporarily fixed to the frame 6 in a predetermined position. As an auxiliary means for taking this position, however, the dental cast can also be temporarily fixed to the frame, using another temporary fixation device.

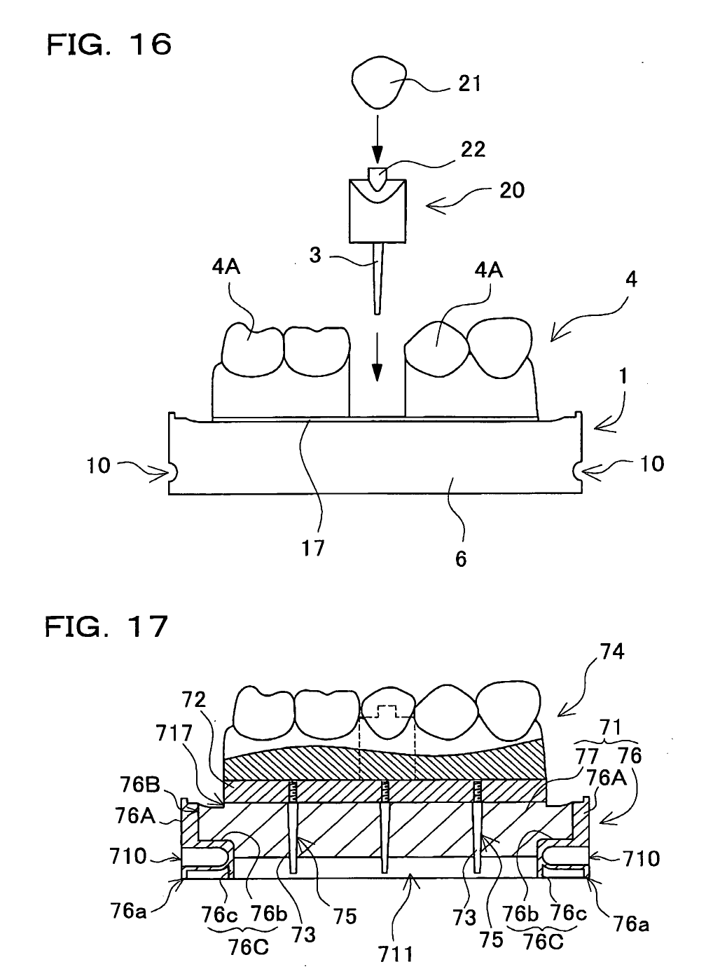

The working model with the above-described structure is used for fabricating various types of dental prostheses in the following manner:
(1) Prior to taking a dental impression from a patient's mouth, the dental surgeon grinds and files a target tooth in advance, which is to be provided with a dental prosthesis, so as to obtain an abutment tooth. As such, the dental cast 4 of the working model has an abutment model 22 formed in a portion for which a prosthetic crown 21 is to be fabricated, as shown in FIG. 16.
(2) Using resin, metal, etc., the dental technician fabricates the prosthetic crown 21 which is to be mounted on the abutment model 22 of the working model, whose operation will be hampered by proximal tooth models 4A situated at opposite sides of the abutment model 22. In order to prevent these proximal tooth models 4A from hampering the operation, the dental technician produces a sectional model 20. This sectional model 20 is so cut as to be able to separate, from the proximal portions, the particular portion for the prosthetic crown 21 to be produced.
(3) The sectional model is produced by sectioning the dental cast 4 of the working model in a predetermined position, as shown in FIG. 16. The dental cast 4 is sectioned at the two proximal sides of the particular portion for which the prosthetic crown 21 is to be produced, that is, at the two proximal sides of the dowel pin 3. The sectional model 20 is detachably mounted via the dowel pin 3 onto the substrate 1 in a predetermined position.
(4) Using the sectional model 20 thus produced, the prosthetic crown 21 to be mounted to the abutment model 22 is produced with resin, metal, etc. The sectional model 20 where the abutment model 22 is separable from the substrate 1 can be efficiently and accurately processed even in the interface with the proximal tooth model 4A, so that the prosthetic crown 21 can thus be efficiently produced.

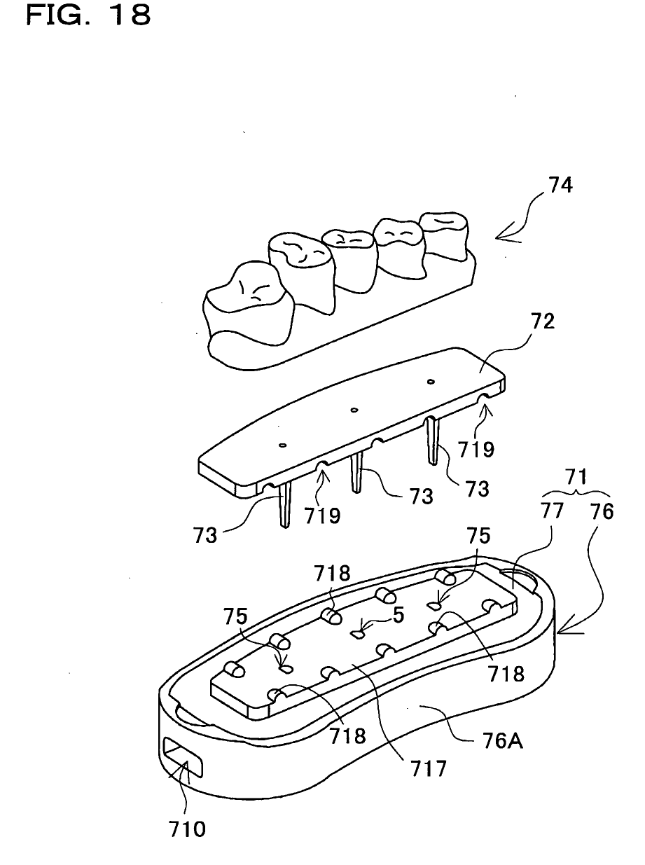

As shown in FIGS. 17 and 18, the working model can also have a fixation plate 72 disposed between the gypsum portion 77 of the substrate 71 and the dental cast 74. The working model shown in these drawings has the dowel pin 73 fixed via the fixation plate 72 to the dental cast 74. As such, the dowel pin 73 is fixed to the fixation plate 72, and the dental cast 74 is fixed to the fixation plate 72.

Like elements in other embodiments shall have an additional numeral 6, 7 or 9 prefixed to the original reference numerals given throughout the drawings, e.g., 910 for 10, and the element with such a prefix shall not be specifically described.

In these drawings, 76A designates the peripheral wall, 76a the lower end opening's rim, 76C the inner wall, 76b the upwardly facing shoulder, 76c the upright wall, 710 the fitting portion, and 711 the recessed portion, respectively.

On the top of the gypsum portion 77 shown, in order to connect the fixation plate 72 in a predetermined position, the plane in interface with the fixation plate 72 is so shaped as to be able to mutually fit in a predetermined position. The shown gypsum portion 77 is provided with a plurality of fitting projections 718 at predetermined intervals along the two sides of the upper surface of the elevated area 717. A plurality of fitting depressions 719 for guiding these fitting projections 718 are correspondingly provided on the lower surface of the fixation plate 72. By guiding the fitting projections 718 into the fitting depressions 719, the gypsum portion 77 and the fixation plate 72 are connected without being mutually displaced. In the shown fitting structure for the gypsum forming portion 77 and the fixation plate 72, the substrate 71 is provided with the fitting projections 718, and the fixation plate 72 is provided with the fitting depressions 719, however it is also possible to reversely have the fitting projections on the fixation plate and the fitting depressions on the substrate. And, the interface between the substrate and the fixation plate may also have concavo-convex structure to allow a mutually fitting contact. In the substrate 71 with the above structure, the fixation plate 72 can be connected in a predetermined position via either the dowel pin 73 or the fitting structure. The dowel pin 73 is connected via the fixation plate 72 to the dental cast 74.

The fixation plate 72 is made of gypsum or plastics, and the upper extremity of the dowel pin 73 is fixed on the fixation plate 72. The fixation plate 72 has a dental cast 74 adhesively fixed onto the top face. Gypsum, quick-dry cyanoacrylate-based adhesive, etc. are used to bond the dental cast 74 to the fixation plate 72. The working model, where adhesive is used for bonding the dental cast 74 to the fixation 72 and gypsum is used for the fixation plate 72, is characterized in that both the adhesive and the fixation plate can be easily cut out.

Like in the previously described working model, the working model with this structure also has the gypsum portion 77 formed by hardening slurry of gypsum filled in the hollow space 76B of the frame 76. In the case of this gypsum portion 77 as well, prior to filling the slurry in the frame 76 or after the slurry is filled but before the slurry has been hardened, the dowel pin 73 fixed to the fixation plate 72 is disposed in a predetermined position of the frame 76, thus defining the connection orifice 75.

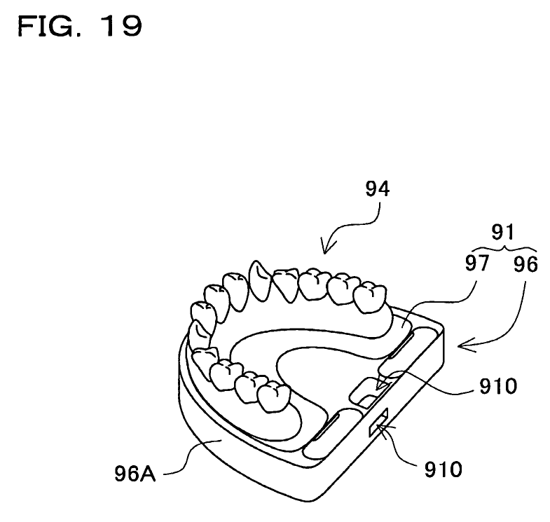

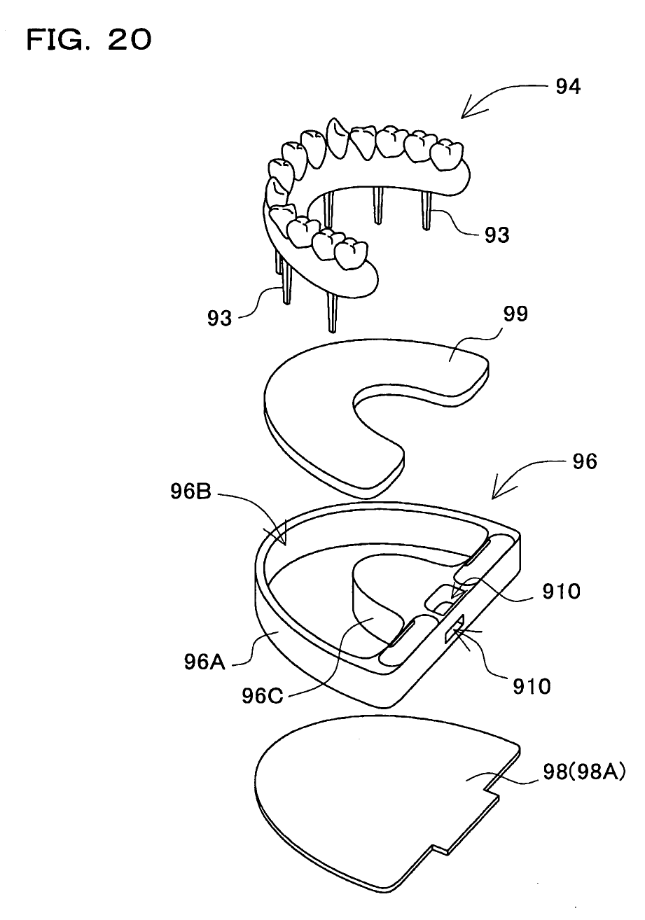

The inventive working model may also be semioval in its entire contour, as illustrated in FIGS. 19 and 20. This working model has a substrate 91 fabricated in a form of conforming to a semioval dental cast 94. In the substrate 91, a gypsum portion 97 is formed by filling and drying slurry of gypsum in the frame 96 having a semioval hollow space 96B which conforms to the dental cast 94, inside a peripheral wall 96A which is open in upper and lower faces. The shown frame 96 has an inner wall 96C semiovally provided oppositely to the curved central portion of the dental cast 94, and the plane of the hollow space 96B is in the form of conforming to the semioval dental cast 94. Although not illustrated, in this frame as well, the hollow space may have an upwardly facing inner shoulder provided, so that the amount of slurry of gypsum to be filled can be reduced. In the case of this working model as well, like in the previously described working model, prior to filling slurry of gypsum in the frame 96 or after the slurry is filled but before the slurry is hardened, the dowel pin 93 fixed to the dental cast 94 is disposed in a predetermined position of the frame 96, thus forming the connection orifice.

In these drawings, 98 designates the closure cover, 98A the sheet material, 99 the insertion plate, and 910 the fitting portion, respectively.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims.

The present application is based on Application No. 2005-350009 filed in Japan on Dec. 2, 2005, the content of which is incorporated herein by reference.

What is claimed is:

1. A working model suited for extraoral fabrication, the working model comprising:
a substrate; and
a dental cast connected via a dowel pin to the substrate in a predetermined position,
wherein the substrate includes:
a frame fabricated with plastics into a form with a peripheral wall being open in upper and lower faces and with a hollow space being defined inside the peripheral wall; and
a gypsum portion formed by hardening slurry of gypsum filled in the hollow space of the frame, and
wherein a connection orifice is provided for allowing the dowel pin to be inserted into the gypsum portion filled in the hollow space of the frame, so that the dowel pin is inserted into the connection orifice, thereby connecting the dental cast to the substrate.

2. The working model suited for extraoral fabrication as recited in claim 1, wherein the frame is made of any of polystyrene, polypropylene, ABS, plastics containing a paper material, and biodegradable plastics.

3. The working model suited for extraoral fabrication as recited in claim 1, wherein a thickness of the peripheral wall of the frame is in a range between 0.3 mm and 10 mm.

4. The working model suited for extraoral fabrication as recited in claim 1, wherein the plastic frame is provided with a fitment part being fittingly connected to a dental articulator.

5. The working model suited for extraoral fabrication as recited in claim 1, wherein a lower end opening of the frame is closed by a separable closure cover.

6. The working model suited for extraoral fabrication as recited in claim 5, wherein the closure cover is a sheet material being releasably connected to the lower end opening's rim of the frame.

7. The working model suited for extraoral fabrication as recited in claim 6, wherein the sheet material is any of a plastic sheet, a waterproofed nonwoven fabric or woven fabric, and oiled paper.

8. The working model suited for extraoral fabrication as recited in claim 5, wherein the closure cover is a cover material made of a rubber-like elastic material being detachably connected to a lower extremity of the frame.

9. The working model suited for extraoral fabrication as recited in claim 8, wherein the cover material of the rubber-like elastic material includes a bottom surface and a peripheral wall, the peripheral wall being disposed around the periphery of the bottom surface to form a mounting recess which is open in an upper face, wherein an internal form of the peripheral wall forming the mounting recess is substantially equal to or slightly smaller than an external form of the frame for tight connection with the peripheral wall of the frame.

10. The working model suited for extraoral fabrication as recited in claim 1, wherein a bottom of the frame is provided with an insertion plate which allows a tip of the dowel pin to be extractably pierced therein and which is separable from the frame when slurry of gypsum in the gypsum portion is hardened.

11. The working model suited for extraoral fabrication as recited in claim 10, wherein the insertion plate is any of expanded polystyrene, expanded urethane, expanded EVA, expanded PVC, resin coated or impregnated paper sheet, and corrugated cardboard sheet.

12. The working model suited for extraoral fabrication as recited in claim 10, wherein a thickness of the insertion plate is in a range between 1 mm and 6 mm.

13. The working model suited for extraoral fabrication as recited in claim 10, wherein an external form of the insertion plate is substantially equal to an internal form of the bottom of the hollow space in the frame.

14. The working model suited for extraoral fabrication as recited in claim 1, wherein the gypsum portion has an elevated area staying above an upper rim of the peripheral wall of the frame.

15. The working model suited for extraoral fabrication as recited in claim 1, wherein the frame has an internal wall integrally formed in the inner side of the peripheral wall, making the inner side of the internal wall the hollow space.

16. The working model suited for extraoral fabrication as recited in claim 15, wherein the frame is provided with the internal wall over the entire inner side of the peripheral wall.

17. The working model suited for extraoral fabrication as recited in claim 15, wherein the frame is provided with the inner wall partially in the inner side of the peripheral wall.

18. The working model suited for extraoral fabrication as recited in claim 15, wherein the plastic frame is provided with a fitment part to be fittingly connected to the dental articulator, and wherein the fitment part is provided in a space between the peripheral wall and the inner wall.
